(19) United States
(12) Patent Application Publication
(10) Pub. No.: US 2009/0263688 A1
(43) Pub. Date: Oct. 22, 2009

(54) FUEL CELL

(76) Inventors: Akira Yajima, Tokyo (JP); Yukinori Akamoto, Chiba-ken (JP); Yuuichi Sato, Tokyo (JP); Nobuyasu Negishi, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/091,514

(22) PCT Filed: Oct. 20, 2006
(86) PCT No.: PCT/JP2006/320943

§ 371 Date: Apr. 25, 2008

(30) Foreign Application Priority Data
Oct. 26, 2005 (JP) 2005-311251

(51) Int. Cl. H01M 8/18; H01M 8/04

(52) U.S. Cl. 429/19; 429/26

(57) ABSTRACT

A fuel cell (10) has a fuel electrode, an air electrode, an electrolyte film (15) held between the fuel electrode and the air electrode, a liquid fuel tank (21) for containing liquid fuel, and a gas-liquid separation film (22) provided between the liquid fuel tank (21) and the fuel electrode. The gas-liquid separation film (22) exchanges heat between water vapor diffused from the fuel cell and the liquid fuel (F) and allows a vaporized component of the liquid fuel (F) to pass to the fuel electrode side.

### TECHNICAL FIELD

The present invention relates to a fuel cell, and more particularly to a small passive type fuel cell.

### BACKGROUND ART

With the progress of semiconductor technology in recent years, electronic equipment such as OA equipment, audio equipment and the like has been made downsized, higher in performance and portable, and there are increasing demands that the battery used for such portable electronic equipment is provided with a high energy density.

Under the circumstances described above, small fuel cells are attracting attention. Especially, a direct methanol fuel cell (DMFC) using methanol as a fuel is considered to excel in miniaturization in comparison with the fuel cell using a hydrogen gas because the DMFC can avoid a difficulty in handling the hydrogen gas and does not need a device which produces hydrogen by reforming an organic fuel.

In the DMFC, methanol is oxidatively decomposed at a fuel electrode (anode) to produce carbon dioxide, proton and electrons. Meanwhile, an air electrode (cathode) produces water from oxygen obtained from air, protons supplied from the fuel electrode through the electrolyte film and electrons supplied from the fuel electrode through an external circuit. And, electric power is supplied by the electrons which flow through the external circuit.

As a fuel supply method of the DMFC, for example, References 1 to 4 disclose a technology that a liquid fuel contained in a fuel tank is directly contacted to the main surface of a liquid fuel impregnation portion to impregnate in the liquid fuel impregnation portion, and the liquid fuel is supplied to the side of the fuel electrode.

The fuel cell causes a power generation reaction by a cathode catalyst layer to produce water. When the power generation reaction progresses to increase a water containing volume in the cathode catalyst layer, the move of the water, which is produced through the electrolyte film, toward an anode catalyst layer is accelerated by the osmotic phenomenon.

In the conventional fuel cell described above, the water which has moved to the anode catalyst layer becomes water vapor, which is then diffused into the fuel tank via the liquid fuel impregnation portion, and the water vapor might be cooled and condensed to become water at such portions. Thus, the fuel concentration lowers at such portions, occasionally causing a problem that prescribed cell output can not be obtained.

In addition to the method of directly supplying the liquid fuel to the fuel electrode side, there may be another method that the vaporized fuel resulting from vaporization of the liquid fuel is supplied to the fuel electrode side. But, according to such a method, a supply rate of the vaporized fuel is restricted depending on the vaporization rate of the liquid fuel. Therefore, when it is tried to generate electric power in a large power amount, the vaporized fuel supply does not catch up, and the fuel cell voltage becomes low, resulting in a problem that it is difficult to obtain power generation output at a prescribed level or higher.

[Reference 1] Japanese Patent No. 3413111 B2

[Reference 2] JP-A 2003-317791 (KOKAI)

[Reference 3] JP-A 2004-14148 (KOKAI)

[Reference 4] JP-A 2004-79506 (KOKAI)

### SUMMARY OF THE INVENTION

According to an aspect of the present invention, there is provided a fuel cell which can provide stable cell output by keeping a liquid fuel concentration at a prescribed level in a fuel tank and the like and accelerating the vaporization of the liquid fuel.

A fuel cell according to an embodiment of the present invention comprises a membrane electrode assembly which is configured of a fuel electrode, an air electrode and an electrolyte film held between the fuel electrode and the air electrode; a fuel tank which contains a liquid fuel; and a gas-liquid separation layer which is provided between the fuel tank and the fuel electrode of the membrane electrode assembly, exchanges heat between water vapor diffused from the fuel electrode and the liquid fuel, and allows the vaporized component of the liquid fuel to pass to the side of the fuel electrode.

### BRIEF DESCRIPTION OF THE DRAWINGS

FIG. 1 is a diagram schematically showing a cross section of the direct methanol fuel cell according to an embodiment of the present invention.

FIG. 2 is a general view illustrating a function of a gas-liquid separation film.

FIG. 3 is a diagram showing a relationship between a current density and an output voltage of the fuel cell.

FIG. 4 is a diagram showing a relationship between an electric power generation time and an output voltage ratio.

### EXPLANATION OF REFERENCE NUMERALS

10 . . . Fuel cell, 11 . . . anode catalyst layer, 12 . . . anode gas diffusion layer, 13 . . . cathode catalyst layer, 14 . . . cathode gas diffusion layer, 15 . . . electrolyte film, 16 . . . membrane electrode assembly, 17 . . . anode conductive layer, 18 . . . cathode conductive layer, 19 . . . anode sealing material, 20 . . . cathode sealing material, 21 . . . liquid fuel tank, 22 . . . gas-liquid separation film, 23, 27 . . . frame, 24 . . . water discharge device, 25 . . . vaporized fuel containing chamber, 26 . . . fuel supply device, 28 . . . moisture retaining layer, 29 . . . surface layer, 30 . . . air introduction ports.

### MODE FOR CARRYING OUT THE INVENTION

An embodiment of the invention will be described below with reference to the drawings.

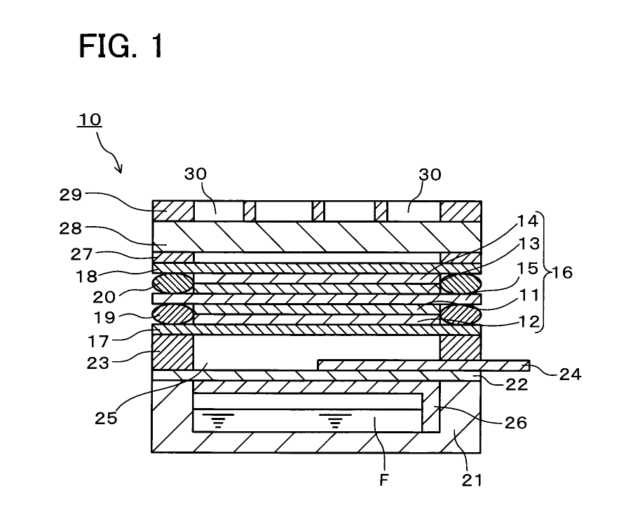

FIG. 1 is a diagram schematically showing a cross section of a direct methanol fuel cell 10 according to the embodiment of the present invention.

As shown in FIG. 1, the fuel cell 10 has as an electromotive portion a membrane electrode assembly (MEA) 16 which is comprised of a fuel electrode composed of an anode catalyst layer 11 and an anode gas diffusion layer 12, an air electrode composed of a cathode catalyst layer 13 and a cathode gas diffusion layer 14, and a proton (hydrogen ion) conductive electrolyte film 15 held between the anode catalyst layer 11 and the cathode catalyst layer 13.

Examples of the catalyst contained in the anode catalyst layer 11 and the cathode catalyst layer 13 can be a single-element metal such as a platinum group element Pt, Ru, Rh, Ir, Os, Pd or the like, an alloy containing the platinum group element, or the like. Specifically, it is desirable to use as the anode catalyst layer 11 Pt—Ru, Pt—Mo or the like which has high resistance to methanol and carbon monoxide, and as the cathode catalyst layer 13 platinum, Pt—Ni or the like, but they are not exclusive. And, a supported catalyst using a conductive carrier such as carbon material, or an unsupported catalyst may be used.

Examples of the proton conductive material configuring the electrolyte film 15 include a fluorine-based resin (Nafion (trade name, a product of DuPont), Flemion (trade name, a product of Asahi Glass) or the like) such as a perfluorosulfonate polymer having a sulfonate group, a hydrocarbon-based resin having the sulfonate group, an inorganic substance such as tungsten acid, phosphotungstic acid or the like, but they are not exclusive.

The anode gas diffusion layer 12 laminated on the anode catalyst layer 11 plays a role of uniformly supplying the fuel to the anode catalyst layer 11 and also has a function to serve as a power collector of the anode catalyst layer 11. Meanwhile, the cathode gas diffusion layer 14 laminated on the cathode catalyst layer 13 plays a role of uniformly supplying an oxidizing agent such as air or the like to the cathode catalyst layer 13 and also has a function as the power collector of the cathode catalyst layer 13. The anode gas diffusion layer 12 has on its surface an anode conductive layer 17, and the cathode gas diffusion layer 14 has on its surface a cathode conductive layer 18. The anode conductive layer 17 and the cathode conductive layer 18 are configured of, for example, a porous layer such as a mesh formed of a conductive metal material such as gold, or a plate or foil having openings. The anode conductive layer 17 and the cathode conductive layer 18 are configured not to leak the fuel and the oxidizing agent from their peripheral edges.

An anode sealing material 19 is formed to have a rectangular frame shape and positioned between the anode conductive layer 17 and the electrolyte film 15 to surround the peripheral edges of the anode catalyst layer 11 and the anode gas diffusion layer 12. Meanwhile, a cathode sealing material 20 is formed to have a rectangular frame shape and positioned between the cathode conductive layer 18 and the electrolyte film 15 to surround the peripheral edges of the cathode catalyst layer 13 and the cathode gas diffusion layer 14. For example, the anode sealing material 19 and the cathode sealing material 20 are formed of a rubber O-ring or the like to prevent the fuel and the oxidizing agent from leaking from the membrane electrode assembly 16. The anode sealing material 19 and the cathode sealing material 20 are not limited to the rectangular frame shape but appropriately configured to comply with the outer edge shape of the fuel cell 10.

A frame 23 (here, a rectangular frame) which is configured to have a shape corresponding to the outer edge shape of the fuel cell 10 is disposed on a gas-liquid separation film 22 which is provided to cover the opening portion of a liquid fuel tank 21 which contains a liquid fuel F. And, the above-described membrane electrode assembly 16 having the anode conductive layer 17 and the cathode conductive layer 18 is laminated on one side surface of the frame 23 so to have the anode conductive layer 17 contacted with it. A vaporized fuel containing chamber 25, which is surrounded by the frame 23, the gas-liquid separation film 22 and the anode conductive layer 17, contains temporarily the vaporized components of the liquid fuel F which has passed through the gas-liquid separation film 22 and functions as a space to uniformly distribute the fuel concentration of the vaporized component. Here, the frame 23 is formed of an electrical insulation material, and more specifically formed of a thermoplastic polyester resin such as polyethylene terephthalate (PET).

A water discharge device 24 is disposed to face a part of the gas-liquid separation film 22 within the vaporized fuel containing chamber 25, and the water discharge device 24 is partly protruded externally from the fuel cell 10. The water discharge device 24 guides water which is on the gas-liquid separation film 22 to the outside of the fuel cell 10. The material configuring the water discharge device 24 is preferably a material having a porosity of 10 to 90% and a water-absorbing ratio of 30 to 90%.

Here, the porosity of the above range is desirable because if the porosity is smaller than 10%, it is hard to secure a satisfactory amount of discharged water and drainage rate. And, if the porosity is larger than 90%, a pore diameter becomes large, and a capillary force lowers, resulting in disadvantages that it is hard to keep water in the water discharge device, the strength of the water discharge device itself is decreased, long use causes deformation or the like, and a drain rate is lowered.

The water-absorbing ratio of the range described above is desirable because if the water-absorbing ratio is smaller than 30%, it is hard to secure a satisfactory amount of discharged water and drainage rate in the same manner as in a case of having a small porosity. And, if the porosity is larger than 90%, the fuel supply device itself is expanded and swelled by the absorbed fuel, and it is hard to keep the shape.

Specifically, the water discharge device 24 is formed of a nonwoven fabric or a woven fabric which is formed of a synthetic fiber such as polyester, nylon, acrylic or the like, an inorganic fiber such as glass, a natural fiber such as cotton, wool, silk, paper or the like, a synthetic resin porous body such as foamed polyurethane, foamed polystyrene, porous polyethylene or the like, or a natural porous body such as sponge. When the water discharge device 24 is impregnated with water, the fuel does not leak externally via the water discharge device 24.

Within the liquid fuel tank 21, a fuel supply device 26 has its one end erected from the bottom of the liquid fuel tank 21 and the other end faced to the gas-liquid separation film 22. This fuel supply device 26 is disposed to come into contact with at least a part of the gas-liquid separation film 22. To accelerate the vaporization of the liquid fuel F, the other end of the fuel supply device 26 is desirably disposed to face the entire surface of one side (on the side of the liquid fuel tank 21) of the gas-liquid separation film 22. This fuel supply device 26 guides the liquid fuel F in the liquid fuel tank 21 to the surface of one side of the gas-liquid separation film 22. A material configuring the fuel supply device 26 has preferably a porosity of 30 to 90% and a water-absorbing ratio of 30 to 90%.

The porosity of the above range is desirable because if the porosity is less than 30%, it is hard to secure a satisfactory fuel supply amount and fuel supply rate. And, if the porosity is larger than 90%, the capillary force lowers or the fuel supply device itself is deformed, resulting in causing a problem that the fuel supply rate lowers.

The water-absorbing ratio of the above range is desirable because if the water-absorbing ratio is less than 30%, it is hard to secure a satisfactory fuel supply amount and fuel supply rate in the same manner as in the case that the porosity is small. And, if the water-absorbing ratio is larger than 90%, the fuel supply device itself is expanded and swelled by the absorbed fuel, and it is hard to keep the shape.

Specifically, the fuel supply device 26 is formed of a nonwoven fabric or a woven fabric which is formed of a synthetic fiber such as polyester, nylon, acrylic or the like, an inorganic fiber such as glass, a natural fiber such as cotton, wool, silk, paper or the like, a synthetic resin porous body such as foamed polyurethane, foamed polystyrene, porous polyethylene or the like, or a natural porous body such as sponge.

The liquid fuel F which is contained in the liquid fuel tank 21 is an aqueous methanol solution having a concentration of more than 50 mol %, or pure methanol. And, the pure methanol desirably has a purity of 95 wt % or more and 100 wt % or less. Here, the vaporized component of the liquid fuel F described above means vaporized methanol when liquid methanol is used as the liquid fuel F, and it means a mixture of the vaporized component of methanol and the vaporized component of water when an aqueous methanol solution is used as the liquid fuel F.

The gas-liquid separation film 22 separates the vaporized component of the liquid fuel F and the liquid fuel F, allows the vaporized component to pass to the anode catalyst layer 11 side, and exchanges heat between the water vapor diffused from the anode catalyst layer 11 and the liquid fuel F guided by the fuel supply device 26. The gas-liquid separation film 22 is desirably configured of a material which allows the passage of the vaporized component of the liquid fuel F and has high heat conductivity. Specifically, the gas-liquid separation film 22 is configured of a material such as silicone rubber, a low-density polyethylene (LDPE) membrane, a polyvinyl chloride (PVC) membrane, a polyethylene terephthalate (PET) membrane, a fluorine resin (e.g., polytetrafluoroethylene (PTFE), tetrafluoroethylene perfluoroalkylvinylether copolymer (PFA) or the like) microporous film or the like. The gas-liquid separation film 22 is configured to prevent the fuel from leaking from its peripheral edge.

Meanwhile, a moisture retaining layer 28 is laminated on the cathode conductive layer 18 with a frame 27 (a rectangular frame), which is configured to have a shape corresponding to the outer edge shape of the fuel cell 10. And, a surface layer 29 which has plural air introduction ports 30 formed for intaking air as oxidizing agent is laminated on the moisture retaining layer 28. This surface layer 29 also plays a role of enhancing the adhesiveness by pressing the laminated body including the membrane electrode assembly 16 and is formed of metal such as SUS 304. The frame 27 is configured of an electrical insulation material in the same manner as the above-described frame 23 and specifically formed of a thermoplastic polyester resin such as polyethylene terephthalate (PET).

The moisture retaining layer 28 plays a role of suppressing water from being evaporated by partially impregnating with the water produced by the cathode catalyst layer 13 and also has a function as an auxiliary diffusion layer to accelerate uniform diffusion of the oxidizing agent to the cathode catalyst layer 13 by uniformly introducing the oxidizing agent into the cathode gas diffusion layer 14. The moisture retaining layer 28 is configured of a material such as a polyethylene porous film or the like. Here, the move of water from the cathode catalyst layer 13 to the anode catalyst layer 11 by the osmotic phenomenon can be controlled by changing the number and size of the air introduction ports 30 in the surface layer 29 which is disposed on the moisture retaining layer 28 to adjust an opening area and the like.

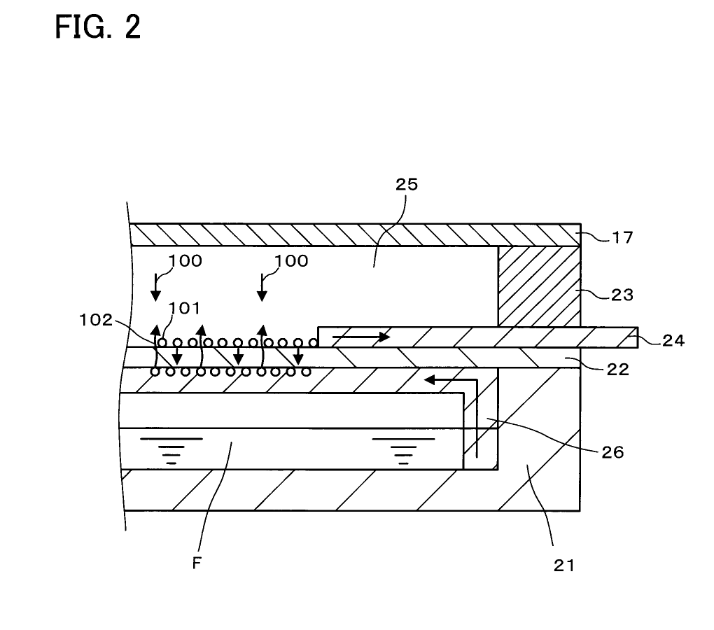

Then, the action of the above-described fuel cell 10 is described below with reference to FIG. 1 and FIG. 2.

FIG. 2 is a general view for illustrating the gas-liquid separation film 22 which exchanges heat between a water vapor 100 diffused from the anode catalyst layer 11 and the liquid fuel F guided by the fuel supply device 26 and allows the passage of the vaporized component of the liquid fuel F.

The liquid fuel F (e.g., an aqueous methanol solution) in the liquid fuel tank 21 is impregnated into the fuel supply device 26 by, for example, the capillary force to come into contact with one surface (the surface on the side of the liquid fuel tank 21) of the gas-liquid separation film 22. And, the water vapor 100 diffused from the anode catalyst layer 11 comes into contact with the other surface (the surface on the side of the vaporized fuel containing chamber 25) of the gas-liquid separation film 22 and is condensed into water 101. At this time, latent heat possessed by at least the water vapor 100 is emitted and conducted through the gas-liquid separation film 22 to reach one surface (the side of the fuel supply device 26) of the gas-liquid separation film 22. And, the conducted heat is transferred to the liquid fuel F which is contacted to one surface of the gas-liquid separation film 22, and the liquid fuel F is vaporized.

Here, heat is exchanged between the condensation of the water vapor and the vaporization of the liquid fuel because methanol has a boiling point lower than water and tends to be vaporized, so that it is thermodynamically stable when water is condensed while methanol is vaporized.

A mixture 102 of the vaporized methanol and the water vapor permeates through the gas-liquid separation film 22 and is temporarily contained in the vaporized fuel containing chamber 25 to have a uniform concentration distribution. Even when the fuel supply device 26 is provided, the mixture 102 occasionally contains a mixture vaporized from the liquid surface of the liquid fuel F, but the liquid fuel F is mainly vaporized from one surface of the gas-liquid separation film 22. Meanwhile, the water 101 produced on the other surface of the gas-liquid separation film 22 cannot pass through the gas-liquid separation film 22 but is absorbed by the water discharge device 24 and discharged out of the fuel cell 10.

The mixture 102 temporarily contained in the vaporized fuel containing chamber 25 is passed through the anode conductive layer 17, diffused by the anode gas diffusion layer 12 and supplied to the anode catalyst layer 11. The mixture 102 supplied to the anode catalyst layer 11 causes an internal reforming reaction of methanol expressed by the following formula (1).

CH₃OH+H₂O→CO₂+6H⁺+6e⁻ (1)

When pure methanol is used as the liquid fuel F, water vapor is not supplied from the liquid fuel tank 21, so that water generated by the cathode catalyst layer 13 and water in the electrolyte film 15 cause the internal reforming reaction of the formula (1) with methanol or cause an internal reforming reaction by another reaction mechanism not requiring water without depending on the internal reforming reaction of the formula (1).

Proton (H⁺) produced by the internal reforming reaction is conducted through the electrolyte film 15 to reach the cathode catalyst layer 13. Meanwhile, air introduced through the air introduction ports 30 of the surface layer 29 is diffused in the moisture retaining layer 28, the cathode conductive layer 18 and the cathode gas diffusion layer 14 and supplied to the cathode catalyst layer 13. The air supplied to the cathode catalyst layer 13 causes the reaction indicated by the following formula (2). This reaction produces water and causes a power generation reaction.

(3/2)O₂+6H⁺+6e⁻→3H₂O (2)

The water produced in the cathode catalyst layer 13 by this reaction is diffused in the cathode gas diffusion layer 14 to reach the moisture retaining layer 28 and partially evaporated from the air introduction ports 30 of the surface layer 29 formed on the moisture retaining layer 28, and the remaining portion of the water is disturbed from being evaporated by the surface layer 29. Especially, when the reaction of the formula (2) proceeds, an amount of water disturbed from being evaporated is increased by the surface layer 29, and a water volume contained in the cathode catalyst layer 13 is increased. In this case, with the progress of the reaction of the formula (2), the water volume in the cathode catalyst layer 13 becomes larger than the water volume in the anode catalyst layer 11. As a result, the water produced in the cathode catalyst layer 13 is accelerated to move to the anode catalyst layer 11 through the electrolyte film 15 by the osmotic phenomenon. Therefore, in comparison with the case that the supply of the water to the anode catalyst layer 11 depends on only the water vapor vaporized from the liquid fuel tank 21, the water supply is accelerated, and the internal reforming reaction of methanol by the above-described formula (1) can be accelerated. Thus, an output density can be increased, and the high output density can be maintained over a long time.

Even when an aqueous methanol solution having a methanol concentration of more than 50 mol % or pure methanol is used as the liquid fuel F, water moved from the cathode catalyst layer 13 to the anode catalyst layer 11 can be used for the internal reforming reaction, so that water can be supplied stably to the anode catalyst layer 11. Thus, the reaction resistance of an internal reforming reaction of methanol can be further lowered, and a long output characteristic and a load current characteristic can be further improved. In addition, the liquid fuel tank 21 can be downsized.

As described above, according to the direct methanol fuel cell 10 of the embodiment, heat can be exchanged between the water vapor 100 diffused from the anode catalyst layer 11 and the liquid fuel F guided by the fuel supply device 26 through the gas-liquid separation film 22. Thus, the vaporization of the liquid fuel F is accelerated, and a power generation current can be increased without largely lowering the voltage, and the output of the fuel cell by power generation can be improved.

And, the water vapor 100 diffused from the anode catalyst layer 11 is condensed into the water 101 on the other surface (surface on the side of the vaporized fuel containing chamber 25) of the gas-liquid separation film 22, so that the water vapor 100 can be prevented from being diffused into the liquid fuel tank 21 through the gas-liquid separation film 22. Thus, the water vapor 100 diffused from the anode catalyst layer 11 can be prevented from being mixed into the liquid fuel F by diffusing into the liquid fuel tank 21 and condensing into water, so that the fuel concentration of the liquid fuel F in the liquid fuel tank 21 can be kept at a prescribed level. Accordingly, the fuel concentration of the liquid fuel F in the liquid fuel tank 21 is prevented from lowering to keep the fuel concentration at a prescribed level, so that the vaporized component of the liquid fuel F having a prescribed fuel concentration can be supplied to the anode catalyst layer 11, and the stable cell output can be obtained.

Besides, the liquid fuel F can be uniformly supplied so as to come into contact with one surface (the surface on the side of the liquid fuel tank 21) of the gas-liquid separation film 22 by the fuel supply device 26, so that the heat exchange between the water vapor 100 diffused from the anode catalyst layer 11 and the liquid fuel F through the gas-liquid separation film 22 can be proceeded efficiently. Thus, the vaporization of the liquid fuel F can be accelerated.

The water 101 produced on the other surface of the gas-liquid separation film 22 can be discharged out of the fuel cell 10 by disposing the water discharge device 24, so that the produced water 101 can be suppressed from disturbing the vaporized component of the liquid fuel F from passing through the gas-liquid separation film 22.

In the above-described embodiment, the direct methanol fuel cell using an aqueous methanol solution or pure methanol as the liquid fuel was described. But, the liquid fuel is not limited to them. For example, it can also be applied to a liquid fuel direct supply type fuel cell using ethyl alcohol, isopropyl alcohol, dimethyl ether or formic acid or an aqueous solution thereof. In any event, a liquid fuel corresponding to the fuel cell is used.

To obtain prescribed cell output, the fuel cell 10 shown in FIG. 1 is generally disposed in parallel in a plurality of numbers, and the individual fuel cells 10 are electrically connected in series to configure a fuel cell. For example, it can be configured to share the single liquid fuel tank 21.

Then, it is described in the following example that excellent output characteristics can be obtained by providing the fuel cell 10 with the fuel supply device 26.

### EXAMPLE 1

The fuel cell according to the present invention used in Example 1 was produced as follows.

First, a perfluorocarbon sulfonic acid solution, water and methoxypropanol were added to platinum-supported carbon black, and the platinum-supported carbon black was dispersed to produce a paste. The obtained paste was coated on porous carbon paper which was a cathode gas diffusion layer of an air electrode. The obtained product was dried at normal temperature to produce the air electrode which was comprised of the cathode catalyst layer and the cathode gas diffusion layer.

A perfluorocarbon sulfonic acid solution, water and methoxypropanol were added to carbon particles which support platinum-ruthenium alloy fine particles, and the carbon particles were dispersed to produce a paste. The obtained past was coated on porous carbon paper which was an anode gas diffusion layer of a fuel electrode. The obtained product was dried at normal temperature to produce the fuel electrode which was comprised of the anode catalyst layer and the anode gas diffusion layer.

As the electrolyte film, a perfluorocarbon sulfonic acid film (Nafion film, a product of DuPont) having a thickness of 30 μm and a moisture content of 10 to 20 wt % was used. The electrolyte film was held between an air electrode and a fuel electrode and hot pressed to produce a membrane electrode assembly (MEA). An electrode area was determined to be 12 cm² for the air electrode and the fuel electrode.

Subsequently, the membrane electrode assembly was held between gold foils having plural openings for introducing air and vaporized methanol to form an anode conductive layer and a cathode conductive layer.

A laminated body of the membrane electrode assembly (MEA), the anode conductive layer and the cathode conductive layer described above was held between two resin frames. A rubber O-ring was held between the electrolyte film and the anode conductive layer and between the electrolyte film and the cathode conductive layer to seal them.

The laminated body held between the two frames was fixed by screwing to a liquid fuel tank with a gas-liquid separation film therebetween so that the fuel electrode side was on the side of the gas-liquid separation film. For the gas-liquid separation film, a silicone sheet having a thickness of 100 μm was used.

In the vaporized fuel containing chamber was provided a water discharge device, which was formed of a polyester nonwoven fabric having a thickness of 500 μm, a porosity of 60% and a water-absorbing ratio of 60%, to face a part of the gas-liquid separation film. And, the water discharge device was partly protruded out of the fuel cell.

In the liquid fuel tank was provided a fuel supply device, which was formed of a polyester nonwoven fabric having a thickness of 500 μm, a porosity of 60% and a water-absorbing ratio of 60%, with one end erected from the bottom of the liquid fuel tank and the other end faced to the gas-liquid separation film. And, the fuel supply device was provided in contact with the entire surface of one side of the gas-liquid separation film.

Meanwhile, a porous plate was arranged on the frame on the air electrode side to form a moisture retaining layer. On the moisture retaining layer was provided a stainless steel plate (SUS 304) having a thickness of 2 mm and air introduction ports (a diameter of 3 mm, a quantity of 60) for intaking air to form a surface layer and fixed by screwing.

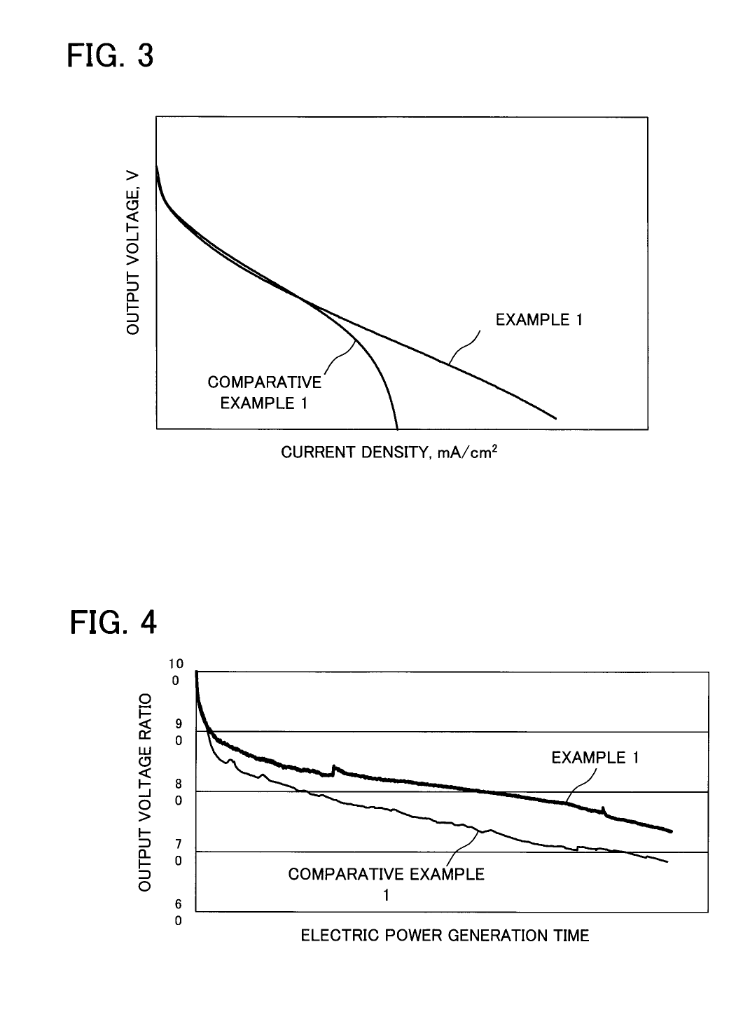

Ten ml of pure methanol was charged into the liquid fuel tank of the fuel cell formed as described above, and a relationship between a current density (mA/cm²), which was a current amount per unit area, and an output voltage (V) of the fuel cell was measured under environments of a temperature of 25° C. and a relative humidity of 50%. The result is shown in FIG. 3. A relationship between an electric power generation time and an output voltage ratio when it was assumed that the output voltage of the fuel cell at the time of starting the power generation was 100 was also measured. The result is shown in FIG. 4.

### Comparative Example 1

The fuel cell used in Comparative Example 1 had the same structure as that of the fuel cell used in Example 1 except that it was not provided with a fuel supply device. And, the measuring method and measuring conditions for measuring a relationship between a current density (mA/cm²) and an output voltage (V) of the fuel cell and a relationship between an electric power generation time and an output voltage ratio were same as those in Example 1. The result of measuring the relationship between the current density (mA/cm²) and the output voltage (V) of the fuel cell is shown in FIG. 3, and the result of measuring the relationship between the electric power generation time and the output voltage ratio is shown in FIG. 4.

### (Study on Measured Results)

It is apparent from FIG. 3 that the output voltage lowers as an electrical charging density of the fuel cell increases, the output voltage drop is small in the fuel cell of Example 1 provided with the fuel supply device, and the obtained power generation output is high.

It is apparent from FIG. 4 that the output voltage ratios of the both cases decrease with the electric power generation time, but the fuel cell of Example 1 provided with the fuel supply device has a smaller decrease rate and can keep a high output voltage.

It was found from the measured results that excellent output characteristics can be obtained by providing the fuel cell with the fuel supply device and by accelerating the heat exchange between the water vapor diffused from the anode catalyst layer and the liquid fuel performed through the gas-liquid separation film.

### INDUSTRIAL APPLICABILITY

The fuel cell according to the embodiment of the present invention can perform the heat exchange between the water vapor diffused from the anode catalyst layer and the liquid fuel guided by the fuel supply device through the gas-liquid separation film. And, mixing of the water vapor diffused from the anode catalyst layer into the liquid fuel tank can be suppressed. Therefore, it is possible to provide the fuel cell that the vaporization of the liquid fuel is accelerated, the power generation current can be increased without causing a large voltage drop, and the fuel concentration of the liquid fuel in the liquid fuel tank can be kept at a prescribed level. Especially, the fuel cell according to the embodiment of the present invention is effectively used for the liquid fuel direct supply type fuel cell.

What is claimed is:

1. A fuel cell, comprising:
a membrane electrode assembly which is configured of a fuel electrode, an air electrode and an electrolyte film held between the fuel electrode and the air electrode;
a fuel tank which contains a liquid fuel; and
a gas-liquid separation layer which is provided between the fuel tank and the fuel electrode of the membrane electrode assembly, exchanges heat between water vapor diffused from the fuel electrode and the liquid fuel, and allows the vaporized component of the liquid fuel to pass to the side of the fuel electrode.

2. The fuel cell according to claim 1, wherein the water vapor is condensed on the surface of the gas-liquid separation layer on the side of the fuel electrode, and the liquid fuel is vaporized on the surface of the gas-liquid separation layer on the side of the fuel tank.

3. The fuel cell according to claim 1, wherein a liquid supply device for supplying the liquid fuel is provided to face at least a part of the surface of the gas-liquid separation layer on the side of the fuel tank.

4. The fuel cell according to claim 3, wherein the liquid supply device is provided with a structure to impregnate and supply the liquid fuel by the capillary force.

5. The fuel cell according to claim 1, wherein a water discharge device for discharging water is provided to face a part of the surface of the gas-liquid separation layer on the side of the fuel electrode.

6. The fuel cell according to claim 5, wherein the water discharge device has a structure that water is impregnated and discharged by the capillary force.
